(19) United States
(12) Patent Application Publication
(10) Pub. No.: US 2005/0281519 A1
(43) Pub. Date: Dec. 22, 2005

(54) Optical fiber welt

(76) Inventor: Raoul Daniel Shrout, Boulder, CO (US)

Correspondence Address: Raoul Daniel Shrout, 722 South Lashley Ln, Boulder, CO, 80305, US

(21) Appl. No.: 10/869,093

(22) Filed: Jun. 16, 2004

(51) Int. Cl. F21V 7/04

(52) U.S. Cl. 385/115; 362/551; 362/554

(57) ABSTRACT

Optical Fiber Welt is a welt comprised of a fiber optic bundle core wrapped in a pliable, translucent plastic material, which when plugged into an illumination source, will illuminate the entire length of the welt. The welt essentially allows for fiber optic cable to be sewn into a piece of upholstery or attached to a desired surface, thus adapting it for that use, and allowing an illumination effect that is affixed within the upholstery.

### CROSS REFERENCE TO RELATED APPLICATIONS

The present application does not claim priority to previous non-provisional utility patents.

### BACKGROUND OF THE INVENTION

1. Field of the Invention

The present invention relates generally to methods of illumination (Class 362), and more particularly to Subclass 565 (Ornamental or Decorative) under Subclass 551 (Light Fiber, Rod, or Pipe).

2. Description of the Prior Art

The upholstery business is a highly competitive and rapidly changing field. There is a constant demand for unique and aesthetically pleasing improvements in existing designs to attract a new customer base.

One way to differentiate an upholstery design is to create an illumination effect which is sewn into the upholstery. This requires a departure from prior concepts, which involved the use of electricity and/or the transference of heat and were inflexible and unable to change color.

### BREIF SUMMARY OF THE INVENTION

A welt, consisting of a fiber optic bundle of indeterminate size restricted to a range of diameters dictated by application, consistent with normal upholstery and ease of installation with typical sewing equipment, and a number of leaky optical fibers wrapped in a thin, pliable, transparent plastic material, which, when plugged into a typical external illumination source will illuminate the entire length of the welt with color as generated by the illumination source.

The present invention creates an inherently safe illumination effect without the transference or presence within the welt of heat or electricity, which could present any hazard such as ignite the upholstery or provide a source of electrical shock, and provides a pliable material that can be sewn into upholstery or attached to a desired surface without cracking or breaking using typical upholstery equipment and techniques.

Other advantages include the following: (i) less expensive, less complex, light-weight illumination; (ii) illumination colors can be selected after upholstery is completed; (iii) ability to change upholstery illumination color without altering the welt or upholstery installed; (iv) illumination effect lasts for the duration light is shown into the flat endpoint from the external light source; (v) welt appears transparent, colorless, when not illuminated by the external source; (vi) moisture does not effect illumination properties of welt.

### BRIEF DESCRIPTION OF THE SEVERAL VEIWS OF THE DRAWING

These advantages will be apparent upon reading the following detailed description of the present invention in conjunction with the accompanying drawings, where:

FIG. 1 is a simplified diagram of a fiber optic core wrapped in a thin, pliable, transparent plastic material.

FIG. 2 is a close up of the fiber optic core and example of illumination source.

### DETAILED DESCRIPTION OF THE INVENTION

The present invention is modeled in the basic structure of welt. It has a core and an outer protective layer, which includes a tube-like structure that extends to form a flat surface used to sew the welt into a piece of upholstery or attach it to a desired surface. In this case, the core is comprised of a bundle of continuous individual fiber optic cables and the outer protective layer and its extension is comprised of a thin, pliable, transparent plastic material. The fiber optic cable is such that light will leak from the entire length of the cable. The plastic material may be chosen to be appropriate for use in any upholstery application.

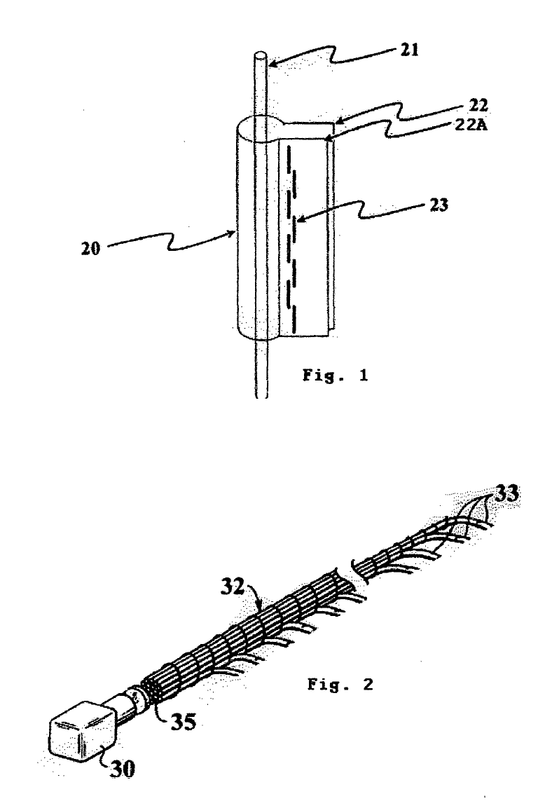

As shown in FIG. 2, the desired numbers of fibers (32) are bundled by loosely twisting the fibers together (33). A sheet of thin, pliable, transparent plastic material (FIG. 1 (20)) is then tightly wrapped around the fiber optic bundle leaving an extension (FIG. 1 (22)) that is suitable for any typical upholstery application as required to sew the welt into the upholstery using typical upholstery equipment.

There are two primary methods of closing the clear plastic wrap described herein. Additional methods using adhesive, staples or any material that completes the enclosure of the optical fiber bundle is in the domain of this patent.

The adjacent portions of the extension (FIG. 1 (22 and 22A)), which are of equal length and width, are then sewn, stapled, glued, clamped or by any appropriate technique that compels the extension to form a sheath around the core (FIG. 1 (23)) forming a tight fitting seam, but not so tight as to puncture or cleave the fibers enclosed.

This process, alternately and preferably, can be accomplished by machine and any die extrusion process. The machine typically contains resin pellets that are heated to a semi liquid form, and, which when cooled, transforms into a transparent, pliable plastic material. The semi-liquid plastic material is slowly cooled while being extruded, along with the fiber optic core, through a die to obtain the desired shape as shown in FIG. 1.

The appropriate total width of the plastic material will be determined by the diameter of the selected fiber optic core, dictated by application, and the required length of the extension formed, (FIG. 1 (22)).

The length of the plastic material will be determined by the functional length of the core extending to or beyond the ends.

In order to illuminate, the present invention must be interfaced directly to an illumination source (FIG. 2 (30)). This requires a flat endpoint (FIG. 2 (35)) appropriately prepared to transmit the light of the illumination source to the interior of the optical fibers. To prepare this endpoint, the fibers are typically separated from the clear plastic tube and extension of the welt for a length convenient for attachment to the selected illuminating source, then bundled together tightly and cut with a hot cutting tool so that they are flush at their ends forming a uniform optical face for the illuminator. Color of illumination of the welt is determined by the color of light shown into the prepared end and will change as light shown into the prepared end is changed.

Typical illumination sources include, but are not limited to:

(i) Solid State Light Sources
(ii) Incandescent Light Sources
(iii) Halogen Light Sources
(iv) Single Color Light Sources
(v) Variable Color Light Sources
(vi) LED's
   Illumination source should be installed and used within its specifications.

1. A welt comprised of
a. A fiber optic bundle core of a range of diameters consistent with normal upholstery and ease of installation with typical sewing equipment, having indeterminate length and number of fibers, dictated by application;
b. A portion of thin, pliable, transparent plastic material, total width determined by the diameter of the above mentioned core and total length determined by the length of the core, wrapped tightly around the core to form a tube, containing the core, and an extension used to attach the welt to upholstery. The adjacent portions of the extension will be of equal length and width and are held together by sewing, stapling, gluing, molding or any appropriate method forming a tight-fitting seam securing the core, but not so tight as to puncture or cleave the fibers within. The width of the extension shall be as required to permit typical installation of welt in typical upholstery. The tube will provide structure and protection for the core. The extension will provide a surface enabling the tube to be sewn between two pieces of fabric or attached to a desired surface;
c. An illumination source interfaced with a flat, prepared endpoint of the welt.

2. A welt comprised of:
a. A fiber optic bundle core in a range of diameters consistent with normal upholstery and ease of installation with typical sewing equipment, length and number of fibers, dictated by application, encased in an extruded transparent, pliable plastic-like material by machine. The machine contains heated resin pellets, which when cooled, transform into a transparent plastic material. The semi-liquid plastic material is slowly cooled while being extruded, along with the core, through a die to obtain the proper shape. The shape being a tube, containing the core, with an extension. The tube will provide structure and protection for the core. The total width of the extension will be as required to permit typical installation of welt in typical upholstery. The extension will provide a surface enabling the tube to be sewn between two pieces of fabric or attached to a desired surface;
b. An illumination source interfaced with a flat, prepared endpoint of the welt.
